(19) United States
(12) Patent Application Publication
(10) Pub. No.: US 2005/0173942 A1
(43) Pub. Date: Aug. 11, 2005

(54) System and method for controlling vehicle doors and windows

(76) Inventors: Benoit Bazin, Les Masures (FR); Frederic Burkat, Bouzy La Foret (FR); Alain Desplebains, Luxembourg (LU); Dominique Attanasio, Chalon Sur Saone (FR); Jean-Pierre Noel, Raon L'etape (FR); Catherine Masson, Sigloy (FR); Stephanie Brien, Chateauneuf-sur-Loire (FR); Jean-Marc Belmond, St. Jean Le Blanc (FR); Emmanuel Huber, Chateauneuf Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 11/030,565

(22) Filed: Jan. 6, 2005

(30) Foreign Application Priority Data
Jan. 9, 2004 (FR) 04 00 177

(51) Int. Cl. B60J 1/00; B60J 5/00

(52) U.S. Cl. 296/146.2

(57) ABSTRACT

A control system for vehicle doors and windows in a vehicle door includes a first openable member, such as a vehicle door, a second openable member, such as a window in the door, and a logic unit that commands the second openable member to open in the event the first openable member fails to open. The logic unit preferably commands a window regulator to actuate if the door fails to open. The vehicle door can be fitted with the system. A method includes the step of commanding the second openable member to open with the logic unit in the event the first openable member fails to open.

### REFERENCE TO RELATED APPLICATIONS

This application claims priority to French patent application FR 04 00 177 filed Jan. 9, 2004.

### BACKGROUND OF THE INVENTION

This invention relates generally to a system and method for controlling motor vehicle openable members that are commonly fitted to motor vehicles. Hereafter, the term “openable member” will be used to denote a window, a sunroof, a hatchback or a door.

A vehicle openable member, such as a window, can be actuated by a manual or electric window opening actuation device. The window opening actuation device opens and closes a window in a vehicle, such as a door window or a quarter window. For example, French Patent Application No. 2 830 895 describes a window regulator, a geared motor and a method of operating the window regulator and the geared motor.

Hereafter, the term “window regulator” will be used to denote a window opening actuation device. A similar device can be used, amongst others, to open an electric sliding door or a sunroof. Hereafter, such a device will be referred to as an “openable member actuation device.”

A vehicle openable member, such as a door, is typically fitted with a lock, for example an electric lock housed in a body of the door. There are known, for example, vehicles fitted with one or more openable members including an electric lock that actuates the closing or opening and the locking or unlocking of the openable member by the electric control. Such a lock is, for example, known from European Patent Application No. 0 887 500 and European Patent Application No. 0 879 926.

An opening command is an action aimed at opening the vehicle openable member, i.e., the release of the openable member after unlocking.

Depending on the vehicle model, the opening can be manual or controlled remotely. For example, in the case of a vehicle fitted with electrically controlled doors (with or without an outside handle), a user can remotely command the door to open using a remote control. When the door is fitted with an outside handle, this provides a manual hold that the user can actuate to command the door to open.

However, the opening command may not produce the anticipated effect. For example, it is possible that the door can fail to open when the vehicle door remains “stuck” to the body of the vehicle, such as when there is frost or when the door is inclined. If the door fails to open, the user may be unable to gain access to the vehicle.

There is therefore a need for a vehicle openable member control system and method that allows a user to access a vehicle even when an openable member of the vehicle fails to open.

### SUMMARY OF THE INVENTION

The present invention provides a vehicle openable member control system including a first vehicle openable member, a second vehicle openable member and a logic unit. The logic unit is designed to command the second openable member to open in the event the first openable member fails to open.

According to one embodiment, the first openable member is a vehicle door including a window regulator and the second openable member is a window that can be actuated by the window regulator. The logic unit commands the window regulator to actuate.

According to one embodiment, the system also includes a first openable member opening sensor, and the logic unit is designed to communicate with the opening sensor. According to another embodiment, the logic unit communicates with a vehicle centralized control unit.

The invention also relates to a vehicle door including a window regulator, a window that can be actuated by the window regulator, and a logic unit to command the window regulator to actuate in the event the door fails to open.

According to one embodiment, the door also includes an electrically controlled door opening actuation device. According to one embodiment, the door does not include an outside handle.

The invention also relates to a method of controlling a vehicle openable member including the steps of commanding a first openable member to open and commanding a second openable member to open by a logic unit in the event the first openable member fails to open.

According to one embodiment, the step of commanding the first openable member to open starts a time delay for the implementation of the step of commanding the second openable member to open.

Other characteristics and advantages of the invention will become apparent when reading the following detailed description of embodiments of the invention, given as an example only.

### BRIEF DESCRIPTION OF DRAWINGS

FIG. 1 illustrates a vehicle door with a window and a logic unit.

### DETAILED DESCRIPTION OF THE PREFERRED EMBODIMENT

The invention provides a vehicle openable member control system including a first openable member, a second openable member and a logic unit. The logic unit commands the second openable member to open in the event the first openable member fails to open. The first openable member is, for example, a vehicle door, and the second openable member is, for example, a window in the door. Thus, the system according to the invention allows a user to gain access to the vehicle even if the first openable member fails to open.

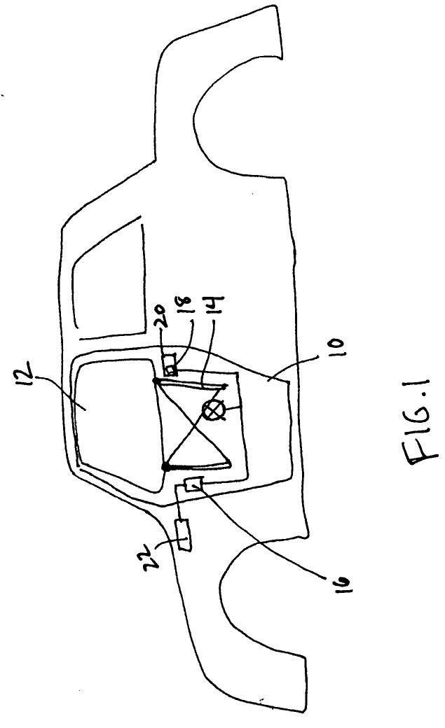

According to one embodiment as shown in FIG. 1, the first openable member is a door 10 of a motor vehicle. The first openable member can be a side door (front/rear) or a sliding door. The invention applies particularly to a door 10 without an outside handle and with electrically controlled opening, and the opening of the door can be controlled remotely.

In one embodiment, the second openable member is a window 12 in the first openable member, in this case in the door 10. The window 12 can be actuated by an electric window regulator 14 housed in the door 10, as is known in the art.

The door 10 can be fitted with an electric lock 20. An electric lock 20 conventionally includes an electrically controlled mechanical actuation mechanism. The mechanism usually includes a motor designed to drive a link, for example, via a worm that meshes with a drum. The driving of the link in one direction or in the other direction by the motor rotates a catch into or out of a closed position and into or out of a locked position.

The door 10 can, if appropriate, include an outside handle. The outside handle usually includes a frame fixed to the door panel, and a pull handle is hinged on the frame. A pivoting arm is hinged in the frame and can be actuated by the outside handle. The pivoting arm is coupled to a transmission component, for example a cable or a rod, which actuates the release lever of the lock.

When the catch is in the closed and locked position, the user can, for example, actuate the door handle to actuate the opening of the door 10. The actuation of the handle is in this case classified as a command by the user to open the door 10. In a normal situation, the command opens the door 10 and the user can then gain access to the vehicle.

In certain types of vehicles, the doors 10 are controlled electrically and do not include an outside handle. A remote control can transition the door 10 from a locked state to a state where the door is effectively open (i.e., released).

The door 10 that constitutes the first openable member of the system can also be fitted with a door opening control switch. The switch can be arranged on the body of the vehicle. The switch is able to translate the command to open the door 10 into an electrical signal. The signal can, for example, be communicated to door electronics that are housed in the door 10 of the vehicle or to a vehicle centralized control unit 22.

The vehicle centralized control unit 22 is, for example, responsible for the management of the vehicle doors or the like. It can also receive data coming from the engine and the wheels. It can additionally manage the driver's position settings, the lighting of the passenger compartment, and the display of information. If appropriate, the vehicle centralized control unit 22 can display an optical signal relating to a state of opening of the vehicle doors or the like on the instrument panel.

The openable member control system according to the invention also includes a logic unit 16 housed, for example, in the door 10 of the vehicle. The logic unit 16 detects or receives and then interprets a signal relating to a command to open the door 10. It can, for example, receive a manual opening command signal from the door 10 when the handle is actuated, for example from the door electronics or the vehicle centralized control unit 22. It can detect the sending of a command from a remote control to open the electric lock 20 or receive a corresponding signal from the vehicle centralized control unit 22.

The vehicle can include an outside opening command sensor 18, for example, situated at the level of the electric lock 20 of the door 10 or in the passenger compartment of the vehicle. The sensor 18 detects a signal to control the unlocking and/or opening of the door 10 that is sent, for example, from a remote control.

The logic unit 16 is also able to receive and interpret a signal relating to the state of opening of the door 10. The logic unit 16 can receive this signal directly from the door opening sensor or, if appropriate, by any control electronics. The control electronics can, for example, be door electronics or a vehicle centralized control unit.

According to the invention, the logic unit 16 of the control system is able to command the opening of a second openable member. In the example described here, the logic unit 16 commands the actuation of the window 12 by the window regulator 14.

During operation and following a command to open the door 10, the logic unit 16 confirms an opening failure if it does not receive a signal indicating that the door 10 is open or if it receives a signal indicating that the door 10 is closed. The logic unit 16 then commands the window 12 to open.

According to one embodiment, the logic unit 16 can command the window 12 to open after a time delay. Preferably, the delay starts from the time of the command to open the door 10. The opening command which starts the time delay corresponds, for example, to a remote opening command of the door 10 of the vehicle when the door 10 does not include an outside handle.

If appropriate, the opening command that starts the time delay corresponds to a pulling of the link, which is caused by the actuation of the outside opening handle of the door 10 of the vehicle. The opening command can also be recorded by door electronics or, if appropriate, passed on to the vehicle centralized control unit 22. The door electronics or the vehicle centralized control unit 22 can in turn send an opening command signal to the logic unit 16 which is designed, in this case, to receive the signal. Thus, following an opening command, the logic unit 16 confirms a failure if the door 10 is not open at the end of the time delay and then commands the window 12 to open.

In addition, for safety reason, the command to open the window 12 can be subject to the condition that the lock is first in the unlocked state. This condition is preferred when the opening command that starts the time delay is the manual actuation of an outside door handle. In this case, the user carries out an unlocking action before carrying out a manual opening command. The logic unit 16 then commands the window 12 to open only if the door 10 is in the unlocked state and if the window 12 does not open in the time delay started by the opening command.

The condition can be implicit in the event that the door 10 is controlled electrically and without a handle, and the user commands the door remotely.

The failure of the door 10 to open can have various causes, such as frost or the inclination of the vehicle. An opening failure can also result from a malfunction caused by an attempt at forced entry or any malicious act.

In the systems of the prior art, when it is not possible to release the door, for example due to frost or inclination of the vehicle, the user cannot gain direct access to the vehicle.

The system according to the invention allows the window 12 to actuate and provides an opening large enough to allow a user to reach inside the vehicle and grab an inside opening control. In any case, the user has an opening large enough to gain access to the vehicle.

The logic unit 16 of the control system according to the invention can be independent of the door electronics and the vehicle centralized control unit 22. The logic unit 16 is designed to communicate with one and/or the other of these components. It can, for example, simply be connected to one and/or the other of these components.

If appropriate, the logic unit 16 of the control system is not an independent unit but its functions are integrated into the door electronics or into the vehicle centralized control unit 22. The ergonomics of the management of the vehicle are thereby improved.

Of course, this invention is not limited to the embodiments described as an example. Thus, although the invention was described in reference to a door and a window in the door, the openable members could be two vehicle doors. Thus, in the event the first door fails to open, the logic unit could actuate an opening actuation device for the second door. The first openable member can also be a door and the second openable member can be a window of another door on the vehicle. More generally, the first openable member and the second openable member can be any two openable members among the openable members of the vehicle.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A vehicle openable member control system comprising:
a first openable member;
a second openable member; and
a logic unit to command the second openable member to open if the first openable member fails to open.

2. The control system in claim 1, wherein:
the first openable member is a vehicle door including a window regulator,
the second openable member is a window that is actuated by the window regulator, and
the logic unit commands the window regulator to actuate the window to open if the vehicle door fails to open.

3. The control system in claim 2, further comprising a first openable member opening sensor, and the logic unit communicates with the first openable member opening sensor.

4. The control system in claim 1, further comprising a first openable member opening sensor, and the logic unit communicates with the first openable member opening sensor.

5. The control system in claim 1, wherein the logic unit communicates with a vehicle centralized control unit.

6. A vehicle door comprising:
a window regulator;
a window that can be actuated by the window regulator; and
a logic unit to command the window regulator to actuate if a vehicle door fails to open.

7. The door in claim 6, further comprising an electrically controlled door opening actuation device.

8. The door in claim 6, wherein the vehicle door does not have an outside handle.

9. A method of controlling a vehicle openable member comprising the steps of:
a) commanding a first openable member to open; and
b) commanding a second openable member to open by a logic unit if the first openable member fails to open.

10. The method in claim 9, wherein the step a) begins a time delay for the implementation of the step b).
